(19) United States
(12) Patent Application Publication
(10) Pub. No.: US 2005/0195544 A1
(43) Pub. Date: Sep. 8, 2005

(54) Current control circuit and method

(76) Inventor: Patrick Ying Cheung Fung, Sacramento, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/792,526

(22) Filed: Mar. 2, 2004

(51) Int. Cl. H02H 3/08

(52) U.S. Cl. 361/93.1

(57) ABSTRACT

A current control circuit receives a power supply voltage on a supply node and is coupled between the supply node and a storage node that is coupled to an energy storage circuit. The current control circuit is operable in a charging mode to limit a current supplied from the supply node to the storage node and operable in a discharge mode to instantaneously supply current to the supply node from the storage node responsive to a voltage on the supply node being less than a threshold value.

### TECHNICAL FIELD

The present invention relates generally to electronic circuits, and more specifically to limiting charging current and controlling discharge current of energy storage devices in electronic circuits.

### BACKGROUND OF THE INVENTION

Every electronic device needs some source of electrical power to function. A typical computer system, for example, includes a power supply that is plugged into an alternating current (AC) outlet and generates direct current power at required voltages to power components in the system. In many electronic systems, such as a typical computer system or a computer network, even a momentary loss of power can result in a significant disruption for users of the system or network. For example, if AC power to a conventional computer system is lost even for only a few seconds, the system may reset and documents on which a user of the system was working may be lost. As a result, many computer systems and networks include backup power supplies to prevent disruption and loss of documents in the event of a failure of AC power.

FIG. 1 is a functional block diagram illustrating an electronic device 100 including conventional power control circuitry 102 that controls power supplied to logic circuitry 104, which includes logic to perform desired functions of the device. An internal power supply 106 supplies an internal supply voltage VIPS to the circuitry 102 and the circuitry also receives an external supply voltage VEPS from an external power source (not shown). A capacitor bank 108 includes a plurality of capacitors (not shown) coupled in parallel, with these capacitors being charged by the power control circuitry 102 to provide a backup source of power that is primarily utilized when switching between the supply voltages VEPS and VIPS.

In operation, the power control circuitry 102 applies either the internal power supply voltage VIPS or the external power supply voltage VEPS as a supply voltage VS to the logic circuitry 104. In normal operation, the power control circuitry 102 applies the internal supply voltage VIPS to the logic circuitry 104 as the supply voltage VS and isolates the external supply voltage VEPS from the logic circuitry. The circuitry 102 also charges the capacitor bank 108 using the internal supply voltage VIPS during this mode of operation. The power control circuitry 102 also monitors the internal supply voltage VIPS to determine whether this voltage is greater than a threshold value. In the event the internal power supply 106 fails and the internal supply voltage VIPS drops below the threshold value, the control circuitry 102 isolates the internal power supply 106 from the logic circuitry 104 and then couples the capacitor bank 108 to the logic circuitry 104 to provide the supply voltage VS. The control circuitry 102 thereafter provides the external supply voltage VEPS as the supply voltage VS to provide power to the logic circuitry 104.

The function of the power control circuitry 102 is to ensure that adequate power is provided to the logic circuitry 104 even when the internal power supply 106 fails. To perform this function, the power control circuitry 102 must include control circuitry (not shown) to detect a failure of the internal power supply and switching components such as relays (not shown) to couple the appropriate power source, namely the supply voltages VEPS, VIPS or the capacitor bank 108, to the logic circuitry 104. The control circuitry and switching components result in the power control circuitry 102 typically requiring relatively complex circuitry to implement. This is true because the circuitry 102 must operate very quickly to ensure that the supply voltage VS does not drop below a minimum threshold level required to ensure proper operation of the logic circuitry 104. For example, if the power control circuitry 102 does not quickly detect the failure of the internal power supply 106 then the supply voltage VS may drop below this minimum threshold value prior to the circuitry coupling the capacitor bank 108 to the logic circuitry 104. Similarly, if the power control circuitry 102 does not thereafter quickly provide the external supply voltage VEPS to the logic circuitry 104, the energy stored in the capacitor bank 108 may be insufficient to maintain the supply voltage VS above the required minimum threshold. Either of these situations could result in erroneous operation or reset of the logic circuitry 104, which adversely affects the operation of the electronic device 100. This relative complexity of the circuitry and components required to implement the power control circuitry 102 also occupies valuable space within the electronic device 100 and also increases the cost of producing the electronic device.

There is a need for power control circuitry that operates extremely quickly while requiring relatively simple components and circuitry to implement.

### SUMMARY OF THE INVENTION

According to one aspect of the present invention, a current control circuit is adapted to receive a power supply voltage on a supply node and is coupled between the supply node and a storage node adapted to be coupled to an energy storage circuit. The current control circuit is operable in a charging mode to limit a current supplied from the supply node to the storage node and operable in a discharge mode to instantaneously supply current to the supply node from the storage node responsive to a voltage on the supply node being less than a threshold value.

### BRIEF DESCRIPTION OF THE DRAWINGS

FIG. 1 is a functional block diagram of an electronic device including conventional power control circuitry for controlling power supplied to logic circuitry in the device.

FIG. 2 is a functional diagram and schematic illustrating a power control circuit according to one embodiment of the present invention.

FIG. 3 is a functional diagram of a computer network including an Ethernet switch containing a power switching and control circuit including the power control circuit of FIG. 2.

### DETAILED DESCRIPTION OF PREFERRED EMBODIMENTS

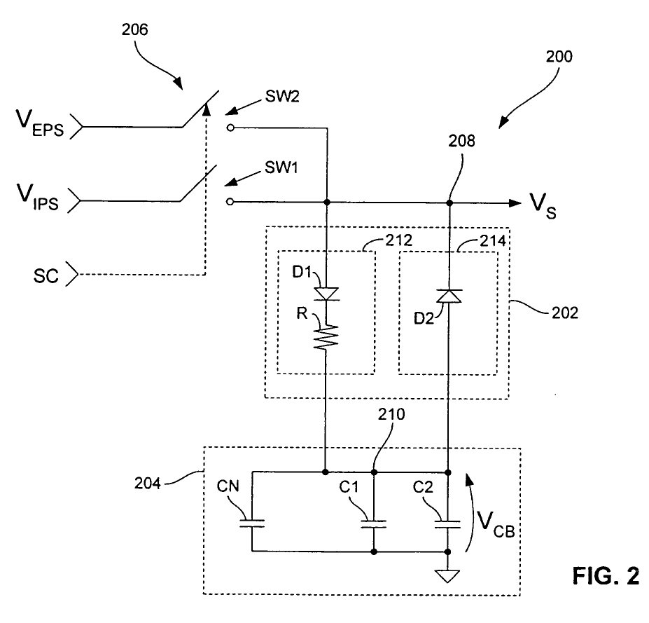

FIG. 2 is a functional block diagram of a power control circuit 200 that operates to instantaneously provide power to maintain a supply voltage VS above a minimum threshold value in the event an internal supply voltage VIPS fails and prior to an external supply voltage VEPS being output as the supply voltage. More specifically, the power control circuit 200 includes a current control circuit 202 that instantaneously supplies current from a capacitor bank 204 to maintain the supply voltage VS above the minimum threshold for the time period between the detection of the failure of the internal supply voltage VIPS and the external supply voltage VEPS being output as the supply voltage, as will be explained in more detail below.

Many of the specific details of certain embodiments of the invention are set forth in the following description and accompanying figures to provide a thorough understanding of such embodiments. One skilled in the art will understand, however, that the present invention may be practiced without several of the details described in the following description. Moreover, in the description that follows, it is understood that the figures related to the various embodiments are not to be interpreted as conveying any specific or relative physical dimensions, and that specific or relative physical dimensions, if stated, are not to be considered limiting unless the claims expressly state otherwise. Further, illustrations of the various embodiments when presented by way of illustrative examples are intended only to further illustrate certain details of the various embodiments, and shall not be interpreted as limiting the scope of the invention.

The power control circuit 200 further includes a switching circuit 206 including a first switch SW1 that selectively applies the internal supply voltage VIPS to a supply node 208 in response to a switch control signal SC. The supply node 208 is a node on which the supply voltage VS is provided to power electronic components (not shown). The switching circuit 206 further includes a second switch SW2 that selectively applies the external supply voltage VEPS to the supply node 208 responsive to the switch control signal SC. The capacitor bank 204 includes a number of capacitors C1-CN coupled in parallel which develop a capacitor bank voltage VCB on a storage node 210.

The current control circuit 202 includes a current limiting element 212 coupled between the supply node 208 and the storage node 210 to provides a current from the supply node to the storage node 210 to charge the capacitors C1-CN. The current limiting element 212 also functions to limit a value of the current from the supply node 208 that is provided to the storage node so that the supply voltage VIPS or VEPS is not damaged when the capacitor bank 204 is initially being charged. Initially, before the capacitor bank 204 is charged a voltage of approximately zero volts will be present on the storage node 210. This means that without the current limiting element 212 the supply voltage VEPS, VIPS coupled to the supply node 208 would initially be coupled directly to ground in this situation, drawing excessive amounts of current from the sources generating the supply voltages and possibly damaging these sources, as will be appreciated by those skilled in the art.

The current control circuit 202 further includes a rectifying element 214 coupled between the supply node 208 and the storage node 210 to provide current from the storage node to the supply node when the supply voltage VS drops below a minimum threshold value. The rectifying element 214 also prevents the flow of current from the supply node to the storage node. In one embodiment, the current limiting element 212 is formed by a series-connected diode D1 and a resistor R, while in another embodiment the current limiting element is formed by the resistor alone. In one embodiment the rectifying element 214 is formed by a diode D2 having its anode coupled to the storage node 210 and cathode coupled to the supply node 208. In other embodiments different circuitry could be utilized in place of the resistor R, diode D1, and diode D2 to perform the equivalent functions, as will be appreciated by those skilled in the art.

In operation of the power control circuit 200, the SC signal is normally applied to the switching circuit 206 to close the switch SW1 and open the switch SW2. As a result, the internal supply voltage VIPS is applied through the switch SW1 as the supply voltage VS on the supply node 208. Initially, such as when an electronic device (not shown) containing the power control circuit 200 is first turned on, the voltage on the storage node 210 and thus the voltage VCB across the capacitors C1-CN is zero volts. At this point, current flows through the current limiting element 212 from the supply node 208 to the storage node 210 to charge the capacitors C1-CN until the voltage VCB is approximately equal to the internal supply voltage VIPS. The current limiting element 212 limits the amount of current that is applied from the supply node to the storage node so that the source (not shown) of the internal supply voltage VIPS is not damaged. The time required to charge the voltage VCB to approximately the internal supply voltage VIPS is determined substantially by the value of the resistor R and the equivalent capacitance of the capacitor bank 204 (i.e., the sum of capacitors C1 to CN). Once the capacitors C1-CN have been charged so that the voltage VCB approximately equals the internal supply voltage VIPS, ideally no current flows through the current limiting element 212 although in practice a small current may still flow due to leakage currents of the capacitors C1-CN, as will be appreciated by those skilled in the art.

At this point, the power control circuit 200 maintains the state until the source of the internal supply voltage VIPS fails and the internal supply voltage drops below the desired value of the supply voltage VS. When the internal supply voltage the VIPS fails, two things occur in the circuit 200. First, the capacitor bank 204 and rectifying element 214 operate in combination to maintain the value of the supply voltage at approximately its desired value until. More specifically, as the value of the supply voltage VS on the node 208 drops the voltage VCB across the capacitors C1-CN, which is initially at the desired value of the supply voltage VS, current flows from the capacitors through the rectifying element 214 to the supply node 208 to maintain the value of the supply voltage at approximately its desired value. Note that in the embodiment of FIG. 2 where the rectifying element 214 is a diode D2, the value of the supply voltage VS at this point would be approximately the forward voltage drop of the diode less than the desired value of the supply voltage. No current flows through the resistor R at this point due to the reversed biased diode D1 in the embodiment of FIG. 2.

The second thing that occurs when the internal supply voltage VIPS fails is that control circuitry (not shown) detects this failure by detecting when the internal supply voltage falls below a minimum threshold. When the control circuitry detects this situation, the control circuitry applies the SC signals to the switching circuit 206 to open the switch SW1 and isolate the failed source of the internal supply voltage VIPS from the supply node 208. At the same time, the SC signals close the switch SW2 to apply the external supply voltage VEPS to the supply node 208. The external supply voltage VEPS thereafter supplies power to components (not shown) coupled to the power control circuit 200 to receive the supply voltage VS. Note that some charge will have been removed from the capacitor bank 204 during the period between when the failure of the internal supply voltage VIPS is first detected and when the external supply voltage VEPS is applied to the node 208. As a result, once the external supply voltage VEPS is applied to the node 208 the capacitor bank will once again charge through the current limiting element 212.

The current control circuit 202 thus operates to perform two functions. First, the current limiting element 212 limits the current drawn from the supply voltage coupled to the supply node 208 to charge the capacitor bank 204 so that the source of the supply voltage is not damaged when the capacitor bank is initially being charged. Second, the rectifying element 202 instantaneously supplies current to the supply node 208 from the storage node 210 whenever the value of the supply voltage VS drops below a minimum threshold value. In this way, the supply voltage VS is maintained at a value sufficient to ensure proper operation of components (not shown) coupled to the circuit 200 to receive the supply voltage. The rectifying element 214 directly couples the storage node to the supply node 208 when the supply voltage VS drops below the minimum threshold value to maintain the value of the supply voltage. The rectifying element also isolates the supply node 208 from the storage node 210 during normal operation of the circuit 200 so that current to charge the capacitor bank flows only through the current limiting element 212.

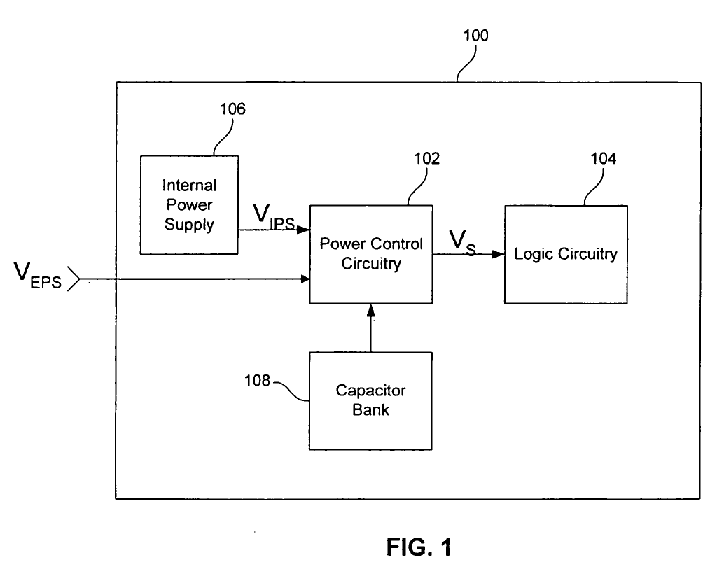

In contrast to the conventional power control circuitry 102 of FIG. 1, the current control circuit 202 instantaneously provides current from the capacitor bank 204 to maintain the value of the supply voltage VS above the minimum threshold value until the external power supply voltage VEPS may be applied to the supply node 208. With the current control circuit 202 there is no significant time lag between the detection of the failure of the internal supply voltage VIPS and the coupling of the capacitor bank 204 to the supply node 208. While there is in fact some finite time lag, the dynamic manner in which the capacitor bank 204 and rectifying element 214 operate will be referred to as instantaneous herein.

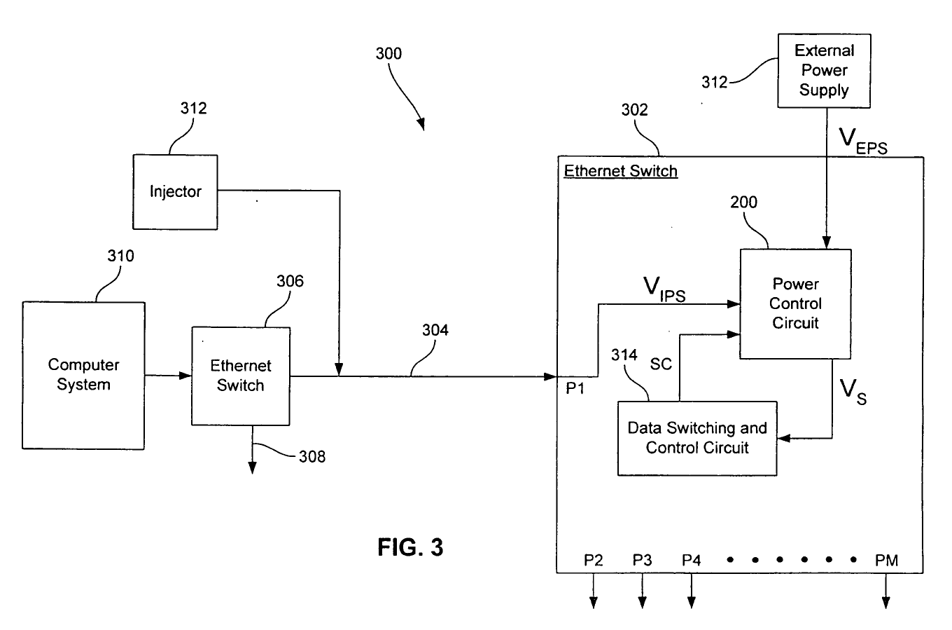

FIG. 3 is a functional diagram of a computer network 300 including an Ethernet switch 302 including the power control circuit 200 of FIG. 2 according to one embodiment of the present invention. The Ethernet switch 302 receives and forwards data packets on plurality of data ports P1-PM to route data packets from a sending device intended receiving device in the network. Although not shown, devices are coupled to some or all of the ports P2-PM, and the port P1 is coupled through an Ethernet cable 304 to a port of a second Ethernet switch 306 that operates in the same way as an Ethernet switch 302. The Ethernet switch 306 includes additional ports 308 coupled to additional devices (not shown) in the computer network 300. A computer system 310 is coupled to another port of the second Ethernet switch 306 that communicates through the Ethernet switches 306 and 302 two other devices in the network 300.

The network 300 further includes a power injector 312 that supplies an internal supply voltage VIPS through the Ethernet cable 304 to the power control circuit 200 in the Ethernet switch 302. An external power supply 312 supplies an external power supply voltage VEPS to the power control circuit 200. A data switching and control circuit 314 receives the supply voltage VS from the power control circuit 200 and includes circuitry for routing data packets between the ports P1-PM. The control circuit 314 further includes control circuitry for monitoring the internal supply voltage VIPS to detect a failure of the source of this voltage, and to generate the switch control signal SC to provide the external supply voltage VEPS to components in the Ethernet switch 302 when such a failure is detected. In the Ethernet switch 302, the power control circuit 200 operates in the same way as previously described with reference to FIG. 2 to provide the supply voltage VS to the circuit 314 and ensure proper operation of the Ethernet switch 302 even upon permanent or temporary loss of the voltage VIPS.

Even though various embodiments and advantages of the present invention have been set forth in the foregoing description, the above disclosure is illustrative only, and changes may be made in detail and yet remain within the broad principles of the present invention. Moreover, the functions performed by the components illustrated in the various embodiments of the present invention can be combined to be performed by fewer elements, separated and performed by more elements, or combined into different functional blocks depending upon the particular applications of the embodiments, as will be appreciated by those skilled in the art. Therefore, the present invention is to be limited only by the appended claims.

1. A current control circuit adapted to receive a power supply voltage on a supply node, comprising:
an energy storage circuit having a storage node, the energy storage circuit operable to store electrical energy from a current supplied to the storage node;
a current limiting element coupled to the storage node and the supply node, the current limiting element operable to limit a current supplied to the storage node responsive to the power supply voltage; and
a rectifying element coupled to the storage node and the supply node, the rectifying element operable to supply current from the storage node to the supply node responsive to the voltage on the supply node dropping below a threshold value and to otherwise isolate the storage node from the supply node.

2. The current control circuit of claim 1 wherein the energy storage circuit comprises a plurality of capacitors coupled in parallel.

3. The current control circuit of claim 1 wherein the current-limiting element comprises a resistive element.

4. The current control circuit of claim 3 wherein the resistive element has a first terminal coupled to the storage node and a second terminal coupled, the current-limiting element further comprising a diode having an anode coupled to the supply node and a cathode coupled to the second terminal of the resistive element.

5. The current control circuit of claim 1 the rectifying element comprises a diode having an anode coupled to the storage node and a cathode coupled to the supply node.

6. A current control circuit adapted to receive a power supply voltage on a supply node and coupled between the supply node and a storage node adapted to be coupled to an energy storage circuit, the current control circuit operable in a charging mode to limit a current supplied from the supply node to the storage node and operable in a discharge mode to instantaneously supply current to the supply node from the storage node responsive to a voltage on the supply node being less than a threshold value.

7. The current control circuit of claim 6 wherein the control circuit includes a resistive element coupled between the supply and storage nodes, and wherein the resistive element limits the current supplied from the supply node to the storage node during the charging mode.

8. The current control circuit of claim 6 wherein the control circuit includes a diode having an anode coupled to the storage node and a cathode coupled to the supply node, and wherein the control circuit instantaneously supplies current to the supply node from the storage node through the diode.

9. The current control circuit of claim 6 wherein the current control circuit further comprises the energy storage element, and wherein the energy storage element comprises a capacitor bank.

10. A power control circuit, comprising:
a switching circuit adapted to receive first and second supply voltages and to receive a control signal, the switching circuit operable to provide a selected one of the first and second supply voltages an a supply node and to isolate the other one of the supply voltages from the supply node, the selected one of the supply voltages being determined responsive to the control signal;
an energy storage circuit having a storage node, the energy storage circuit operable to store electrical energy from a current supplied to the storage node;
a current limiting element coupled to the storage node and the supply node, the current limiting element operable to limit a current supplied to the storage node responsive to the selected one of the first and second supply voltages applied on the supply node; and
a rectifying element coupled to the storage node and the supply node, the rectifying element operable to supply current from the storage node to the supply node responsive to the voltage on the supply node dropping below a threshold value and to otherwise isolate the storage node from the supply node.

11. The power control circuit of claim 10 wherein the energy storage circuit comprises a plurality of capacitors coupled in parallel.

12. The power control circuit of claim 10 wherein the current-limiting element comprises a resistive element.

13. The power control circuit of claim 12 wherein the resistive element has a first terminal coupled to the storage node and a second terminal coupled, the current-limiting element further comprising a diode having an anode coupled to the supply node and a cathode coupled to the second terminal of the resistive element.

14. The power control circuit of claim 10 wherein the rectifying element comprises a diode having an anode coupled to the storage node and a cathode coupled to the supply node.

15. A network switch circuit, comprising:
an internal power supply operable to develop an internal power supply voltage;
a power control circuit coupled to the internal power supply to receive the internal power supply voltage and adapted to receive an external power supply voltage, the power switching circuit including,
a switching circuit coupled operable in response to a switch control signal to provide a selected one of the internal and external power supply voltages an a supply node and to isolate the other one of the supply voltages from the supply node, the selected one of the supply voltages being determined by the switch control signal;
an energy storage circuit having a storage node, the energy storage circuit operable to store electrical energy from a current supplied to the storage node;
a current limiting element coupled to the storage node and the supply node, the current limiting element operable to limit a current supplied to the storage node responsive to the selected one of the internal and external power supply voltages applied on the supply node; and
a rectifying element coupled to the storage node and the supply node, the rectifying element operable to supply current from the storage node to the supply node responsive to the voltage on the supply node dropping below a threshold value and to otherwise isolate the storage node from the supply node; and
data switching and control circuitry coupled to the supply node of the switching circuit to receive the selected on of the supply voltages, the data operable to receive and transmit data through the data ports.

16. The network switch circuit of claim 15 wherein the network switch circuit comprises an Ethernet switch circuit and each data port is adapted to receive an Ethernet cable.

17. The network switch circuit of claim 16 wherein the switching circuit is further operable in a high capacity mode to couple both the internal and external power supply voltages to selected circuitry in the data switching and control circuitry.

18. A computer network, comprising:
an external power supply operable to supply an external power supply voltage;
a network switch circuit, including,
an internal power supply operable to develop an internal power supply voltage;
a power control circuit coupled to the internal power supply to receive the internal power supply voltage and coupled to the external power supply to receive the external power supply voltage, the power switching circuit including,
a switching circuit coupled operable in response to a switch control signal to provide a selected one of the internal and external power supply voltages an a supply node and to isolate the other one of the supply voltages from the supply node, the selected one of the supply voltages being determined by the switch control signal;
an energy storage circuit having a storage node, the energy storage circuit operable to store electrical energy from a current supplied to the storage node;
a current limiting element coupled to the storage node and the supply node, the current limiting element operable to limit a current supplied to the storage node responsive to the selected one of the internal and external power supply voltages applied on the supply node; and
a rectifying element coupled to the storage node and the supply node, the rectifying element operable to supply current from the storage node to the supply node responsive to the voltage on the supply node dropping below a threshold value and to otherwise isolate the storage node from the supply node; and
data switching and control circuitry coupled to the supply node of the switching circuit to receive the selected on of the supply voltages, the data switching and control circuitry including a plurality of data ports and the circuitry operable to receive and transmit data through the data ports, and further operable to apply the switch control signal to the switching circuit; and
a computer system coupled to a port of the data switching.

19. The computer network of claim 18 wherein the network switch circuit an Ethernet switch circuit and each data port is adapted to receive an Ethernet cable.

20. The computer network of claim 19 wherein the external power supply comprises an injector circuit that is coupled to the power control circuit through an Ethernet cable to supply the external power supply voltage.

21. The computer network of claim 20 wherein the switching circuit is further operable in a high capacity mode to couple both the internal and external power supply voltages to selected circuitry in the data switching and control circuitry.

22. A method of controlling a current supplied to a supply node, the method comprising:
applying a supply voltage to the supply node;
charging an energy storage node with a portion of the current available from the supply node;
detecting when a value of the supply voltage on the supply node is less than a threshold value; and
instantaneously supplying current from the energy storage node to the supply node when the value of the supply voltage is less than the threshold value.

23. The method of claim 22 wherein applying a supply voltage to the supply node comprises supplying a selected on of at least two supply voltages to the supply node responsive to a control signal.

24. The method of claim 22 wherein charging an energy storage node with a portion of the current available from the supply node comprises coupling a resistive element between the supply and storage nodes, the resistive element having a value to limit the portion of the current that charges the storage node.

25. The method of claim 22 wherein instantaneously supplying current from the energy storage node comprises coupling an anode of a diode to the storage node and coupling a cathode of the diode to the supply node.
